(19) United States
(12) Patent Application Publication
(10) Pub. No.: US 2004/0032331 A1
(43) Pub. Date: Feb. 19, 2004

(54) Non-contact electronic tag reading device

(75) Inventor: Eiji Okamura, Tokyo (JP)

Correspondence Address: FULBRIGHT AND JAWORSKI L L P, PATENT DOCKETING 29TH FLOOR, 865 SOUTH FIGUEROA STREET, LOS ANGELES, CA, 900172576

(73) Assignee: Leading Information Technology Institute, Inc

(21) Appl. No.: 10/223,835

(22) Filed: Aug. 19, 2002

(51) Int. Cl. G08B 13/14

(52) U.S. Cl. 340/572.7; 340/572.8; 235/439

(57) ABSTRACT

A non-contact electronic tag reading device reliably reads a non-contact electronic tag when an operator holding an article to which a non-contact electronic tag has been attached passes by. The non-contact electronic tag reading device includes a partition 3 (for example, a door or the like) that is provided in a passage leading to a warehouse or stockroom, and a non-contact electronic tag reading antenna 4. The non-contact electronic tag reading antenna 4 is attached to the partition 3 and faces the passage. When an operator holding an article 61 to which a non-contact electronic tag 7 has been attached is passing past the partition 3, the data from the non-contact electronic tag 7 is read by the non-contact electronic tag reading antenna 4.

### TECHNICAL FIELD

The present invention relates to a non-contact electronic tag reading device such as may be installed at an entrance or exit of a warehouse or stockroom containing articles such as apparel, jewelry, shoes, handbags, wallets and other merchandise to which are attached non-contact electronic tags.

### BACKGROUND

When selling apparel, jewelry, shoes, handbags, wallets, and other merchandise, it is necessary to maintain a large number of sizes, colors, and the like of merchandise in the stockroom inside the store in order to immediately meet customer demands and to provide an aesthetically pleasing display.

Furthermore, because a number of store employees remove the articles from and add articles to the stockroom in accordance with customer demands, inventory control becomes arduous.

In addition, because these articles have been subdivided by design, color, size, and the like, there are an enormous number of classes of articles to control, and thus a sufficient amount of information cannot be attached to a conventional bar code. That is why there have been attempts to put an electronic tag with a large storage capacity to practical use, and because there are a large number of articles having an indeterminate shape, a contact type of reading tag may become buried inside an article, making the task of reading the tag arduous. Therefore, the use of a non-contact electronic tag has been proposed in which the tag can be read as is even if it is buried inside an article.

A device has also been proposed that, by installing a non-contact electronic tag reading antenna in a passage or the like, automatically reads a non-contact electronic tag as articles are transported. It is well known that this type of electronic tag reading device installed in a passage is being used to prevent theft, etc.

A conventional non-contact electronic tag reading device shown in FIG. 12 is constructed from two non-contact electronic tag reading antennas 4, which are installed on a floor surface 1 that is enclosed by wall surfaces 2 so as to sandwich the passage from both sides.

With a conventional non-contact electric tag reading device constructed and installed in this manner, when an operator who is carrying an article having a non-contact electric tag attached thereto moves over the floor surface 1 of the passage, the non-contact electronic tag passes between the two non-contact electronic tag reading antennas 4, the non-contact electronic tag approaches a suitable distance from one or both of the non-contact electronic tag reading antennas 4 for tag reading to occur, tag reading takes place, and the operator who transports the article does not need to make a special effort for the purpose of tag reading.

However, in the conventional non-contact electronic tag reading device shown in FIG. 12, the biggest drawback is that there must be a large distance within which the non-contact electric tag is readable.

In the conventional non-contact electronic tag reading device shown in FIG. 12, because the path that a non-contact electronic tag attached to an article will take through the gap between the two non-contact electronic tag reading antennas 4 cannot be determined, the distance within which the non-contact electronic tag is readable must be made half as large as the gap between the two non-contact electronic tag reading antennas 4, in order to ensure that the non-contact electronic tag that is passing through will be read reliably.

Because the operator must pass through the gap between the two non-contact electronic tag reading antennas 4, the distance within which the non-contact electronic tag is readable must be between 40 and 50 cm in order to allow the operator to freely pass through the gap.

In order to enlarge the distance within which the non-contact electronic tag is readable, it is necessary to increase the electrical power of the signal. However, making the electrical power of the signal larger is a burden from the electric power aspect, and there will be a great deal of harm from unnecessary electromagnetic wave radiation.

In addition, the conventional non-contact electronic tag reading device shown in FIG. 12 has another drawback in that articles cannot be stored in the space between the two non-contact electronic tag reading antennas 4.

If by chance an article is placed in this space, the non-contact electronic tag attached to said article will be constantly read by the non-contact electronic tag reading antennas 4, the ability to distinguish between that tag and a tag that is supposed to be read out as it passes between the non-contact electronic tag reading antennas 4 for an inventory management purposes is lost, and this will cause difficulty with the present object of managing the inventory.

Strictly speaking, the space between the two non-contact electronic tag reading antennas 4 is not the only region in which an article cannot be placed. Because of the radiation characteristics of electromagnetic waves, when one tries to enlarge the distance within which the non-contact electronic tags are readable, the radiation in the vicinity around the two non-contact electronic tag reading antennas 4 and a distance which is influenced by them will, as noted previously, be inevitably increased.

In a small retail shop, because the shop floor is maintained for the purpose of merchandise display, it is difficult to allocate sufficient space for inventory, and in many cases, this will cause a large economic burden.

In this situation, not being able to place articles in the vicinity of the non-contact electronic tag reading antenna 4 is a critical defect in the conventional non-contact electronic tag reading device shown in FIG. 12.

In addition, the conventional non-contact electronic tag reading device shown in FIG. 12 has a drawback in that the non-contact electronic tag can only pass between the non-contact electronic tag reading antenna 4 at a fixed angle.

It is well known that the relative angular relationship between the non-contact electronic tag and the non-contact electronic tag reading antennas has a strong influence on the distance within which the tag can be read.

Thus, in the conventional non-contact electronic tag reading device shown in FIG. 12, even when a non-contact electronic tag passes therethrough at a relative angle that minimizes the readable distance, the required readable distance must be obtained, and this again will be one factor in the increase of the electrical power of the signal and the increase in unnecessary radiation.

### SUMMARY

The non-contact electronic tag reading device according to the present invention includes a partition placed in a passage and a non-contact electronic tag reading antenna installed on the passage-facing side of the partition.

The partition is preferably movable, in which case it could for example be a sliding door, a hung door that pivots on one edge thereof, a revolving door that is supported on a rotational axis, or a curtain. The non-contact electronic tag reading antenna is preferably installed adjacent to the area around the opening of the sliding door, the open side around the hung door, the outermost area around the revolving door, or the area around the opening of the curtain.

The position in which the non-contact electronic tag reading antenna is installed is preferably between 50 and 180 cm from the floor of the passage.

The non-contact electronic tag reading antenna is an antenna for reading a non-contact electronic tag of a type suitable for attachment to apparel, jewelry, shoes, handbags, wallets, or other merchandise.

The partition may be installed at the entrance/exit of a warehouse that stores apparel, jewelry, shoes, handbags, wallets, or other merchandise, or at the entrance/exit of a stockroom that is in a store or adjacent thereto.

### BRIEF DESCRIPTION OF DRAWINGS

Certain exemplary embodiments of the non-contact electronic reading device of the present invention will now be described with reference to the appended Drawings, in which:

FIG. 1 shows a first embodiment of the non-contact electronic tag reading device of the present invention.

FIG. 2 shows a non-contact electronic tag being read by the embodiment shown in FIG. 1.

FIG. 3 shows a second embodiment of the non-contact electronic tag reading device of the present invention.

FIG. 4 shows a third embodiment of the non-contact electronic tag reading device of the present invention.

FIG. 5 shows a non-contact electronic tag being read by the embodiment shown in FIG. 3.

FIG. 6 depicts the positional and angular relationships between the electric field generated by a non-contact electronic tag reading antenna and a non-contact electronic tag antenna.

FIG. 7 depicts the positional and angular relationships between the non-contact electronic tag reading antenna attached to the non-contact electronic tag reading device of the present invention and a non-contact electronic tag antenna.

FIG. 8 depicts the positional and angular relationships between the non-contact electronic tag reading antenna attached to the non-contact electronic tag reading device of the present invention and a non-contact electronic tag antenna.

FIG. 9 shows a fourth embodiment of the non-contact electronic tag reading device of the present invention.

FIG. 10 shows a fifth embodiment of the non-contact electronic tag reading device of the present invention.

FIG. 11 shows a non-contact electronic tag being read by the embodiment of FIG. 1.

FIG. 12 shows an example of a conventional non-contact electronic tag reading device.

### DETAILED DESCRIPTION OF EXEMPLARY EMBODIMENTS

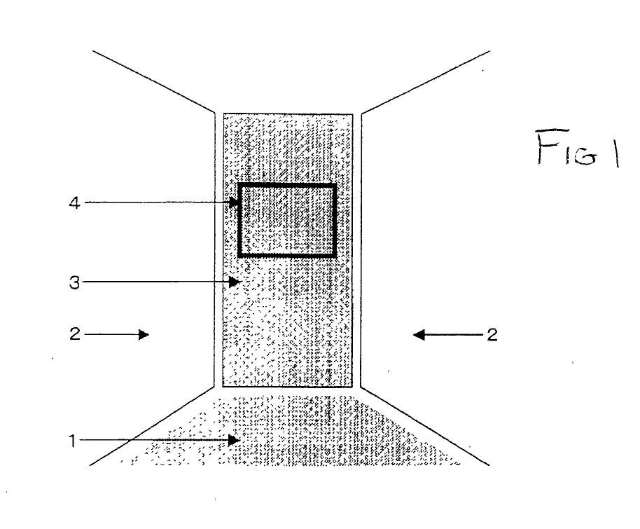

An embodiment of the non-contact electronic reading device according to the present invention shown in FIG. 1 has a partition 3, and a non-contact electronic reading antenna 4. The partition 3 is installed on a passage floor surface 1 that is defined by two wall surfaces 2 such that it screens the forward passage direction. The non-contact electronic reading antenna 4 is attached to the passage-facing side of the partition 3.

The passage floor surface 1 in FIG. 1 is an exit path of an in-store stockroom that stores apparel, jewelry, shoes, handbags, wallets, and other merchandise. The partition 3 serves to screen the interior of the stockroom from customer view.

FIG. 2 shows a non-contact electronic tag 7 attached to an article 61 being read in the embodiment shown in FIG. 1.

In FIG. 2, an operator 5 is carrying a mound-shaped article 61 to which the non-contact electronic tag 7 is attached, and is moving toward the partition 3 to which the non-contact electronic reading antenna 4 is attached along the passage floor surface 1.

In FIG. 2, when operator 5 attempts to move along the passage, he or she will inevitably come into contact with the partition 3 and must move it.

Because the manner in which the partition 3 moves differs according to the type of partition 3, examples of various types will be described below. In all cases, the hand in which the operator 5 holds the article 61, i.e., the non-contact electronic tag 7, must approach the partition 3 until it comes into contact therewith.

Thus, the non-contact electronic tag 7 will be brought sufficiently close to the non-contact electronic reading antenna 4 attached to the partition 3, and the reading of the non-contact electronic tag 7 will take place.

The distance between the non-contact electronic tag 7 to be read in this way and the non-contact electronic reading antenna 4 is at most within the shape of the article 61.

Thus, the communication distance of 40 to 50 cm needed with a conventional non-contact electronic reading device will become unnecessary, and the problems with the electrical power of the signal and unnecessary electromagnetic radiation will be reduced.

In particular, articles such as apparel, jewelry, shoes, handbags, wallets, and other merchandise can be sufficiently read without contact at a communication distance of 10 to 20 cm because the shapes of these articles are sufficiently small.

Furthermore, in the non-contact electronic tag reading device shown in FIG. 1, because the read area of the non-contact electronic tag reading antenna 4 is limited to the vicinity of one non-contact electronic tag reading antenna 4, the region in which articles cannot be stored can be made much smaller than with a conventional non-contact electronic tag reading device.

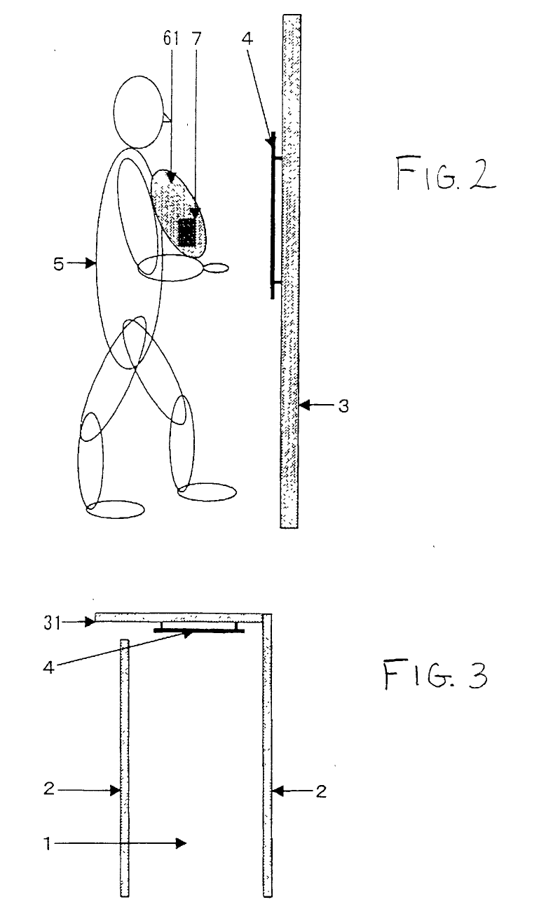

FIG. 3 is an overhead view of an embodiment of the non-contact electronic tag reading device according to the present invention that employs a sliding door.

The embodiment shown in FIG. 3 has a sliding door 31 as a screen, and a non-contact electronic tag reading antenna 4. The sliding door 31 is disposed such that it screens the passage direction of the passage floor surface 1 that is defined by two wall surfaces 2. The non-contact electronic tag reading antenna 4 is installed such that it is adjacent to the open side of the passage-screening side of the sliding door 31. When one is proceeding down the passage, the sliding door 31 is constructed such that it moves to the left together with the non-contact electronic tag reading antenna 4.

In the embodiment shown in FIG. 3 constructed in this manner, if an operator 5 approaches and attempts to open the sliding door 31 with his or her hand as shown in FIG. 2, the non-contact electronic tag 7 attached to the mound-shaped article 61 will inevitably approach the non-contact electronic tag reading antenna 4 and the non-contact electronic tag 7 will be read.

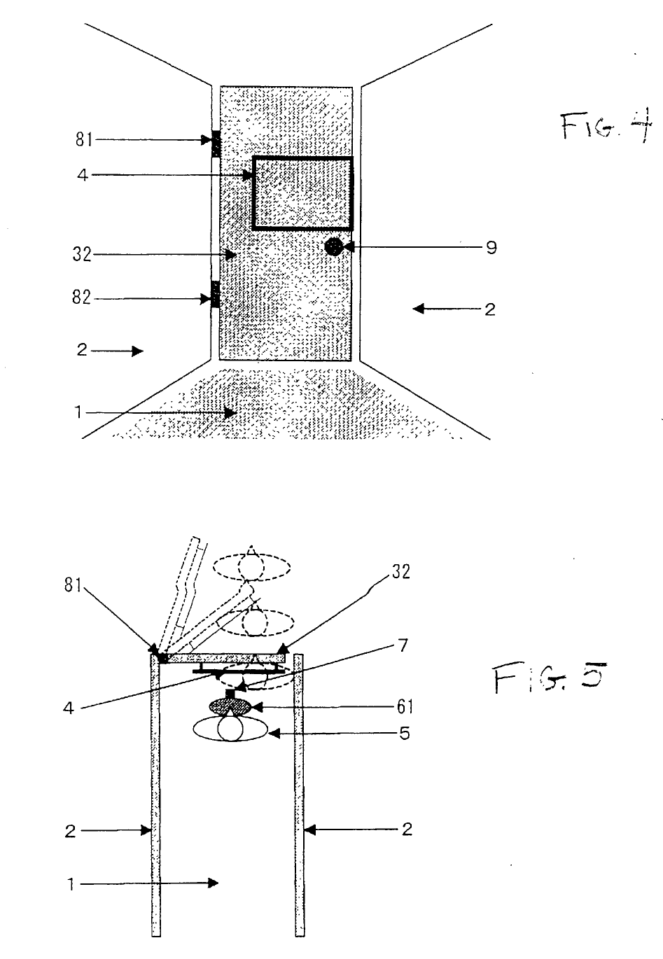

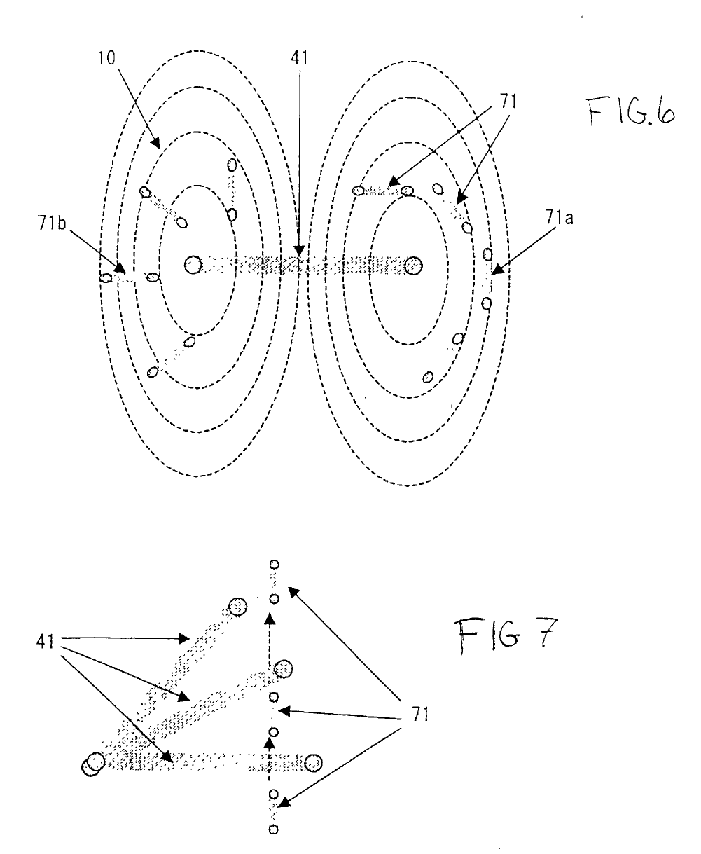

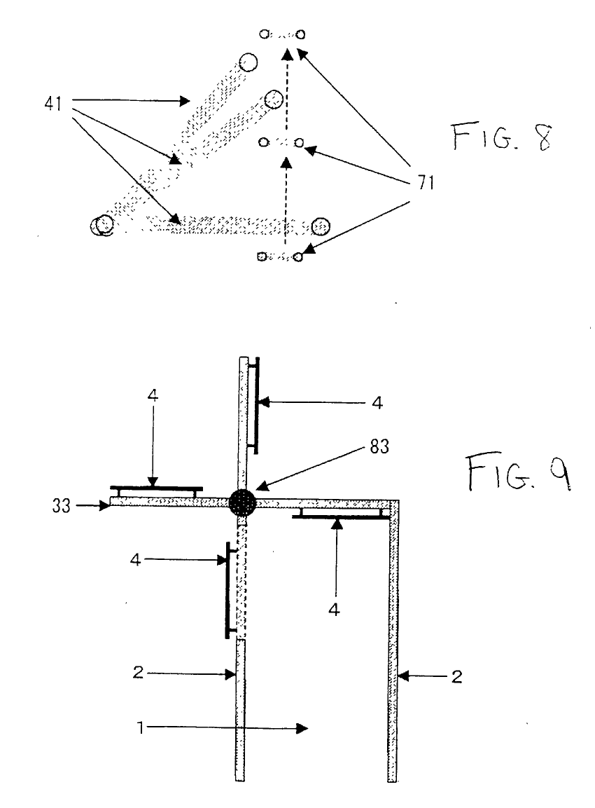

FIG. 4 shows an embodiment of the non-contact electronic tag reading device according to the present invention that employs a hung door as the screen.

The embodiment shown in FIG. 4 has a hung door 32 as the screen and non-contact electronic tag reading antenna 4. The hung door 32 is disposed such that it screens the passage direction of the passage floor surface 1 that is defined by two wall surfaces 2. The non-contact electronic tag reading antenna 4 is attached to the passage-screening side of the hung door 32, and the hung door 32 is secured to one of the wall surfaces 2 by means of hinges 81 and 82. The hung door 32 is constructed such that it opens and closes when a doorknob 9 is pushed.

In the embodiment shown in FIG. 4 constructed in this manner, if an operator 5 approaches and attempts to open the hung door 32 and grasps the doorknob 9 with his or her hand as shown in FIG. 2, the non-contact electronic tag 7 attached to the mound-shaped article 61 will inevitably approach the non-contact electronic tag reading antenna 4 and the non-contact electronic tag 7 will be read.

FIG. 5 is an overhead plan view of the embodiment shown in FIG. 4, in which an operator 5 pushes on the hung door 32, opens it, and proceeds down the passage.

In FIG. 5, the operator 5 carrying the mound-shaped article 61, to which a non-contact electronic tag 7 has been attached, near his or her chest is proceeding up the passage floor surface 1 that is defined by two wall surfaces 2. The hung door 32 to which the non-contact electronic tag reading antenna 4 is attached is itself attached to an edge portion of one of the wall surfaces 2, and opens the passage by changing the fulcrum angle of the hinge 81 as indicated by the dashed lines as the operator 5 moves along as also indicated by the dashed lines.

The non-contact electronic tag 7 is fixed to the mound-shaped article 61, and it moves without changing its angle with respect to the traveling direction of the operator 5.

In other words, when the non-contact electronic tag 7 is read, the relative angle between it and the non-contact electronic tag reading antenna 4 changes, and this allows non-contact electronic tag reading to occur with excellent results.

FIG. 6 shows both the positional and angular relationships between the electric field produced by the non-contact electronic tag reading antenna and the non-contact electronic tag reading antenna.

In FIG. 6, a coil 41 of a non-contact electronic tag reading antenna forms an electric field in order to read a non-contact electronic tag, and coils 71 of non-contact electronic tags are disposed in lines of electric force 10 in various positions and at various angles.

In order to read a non-contact electronic tag, an electric force is supplied to the non-contact electronic tag by producing an induced electromotive force in the coil 71 of the non-contact electronic tag by means of an electric field produced by the coil 41 of the non-contact electronic tag. Furthermore, because a signal is produced by a change in this electric field, the distance within which the non-contact electric tag is readable is determined by how much the electric lines of force 10 that the coil 41 of the non-contact electronic antenna generates intersect with the coils 71 of the non-contact electronic tags.

Thus, in FIG. 6, each coil 71 of the non-contact electronic tags disposed in the electric lines of force 10 obtains a different induced electromotive force.

With the coil 71a of the non-contact electronic tag shown on the right side of FIG. 6, one can see that there are few electric lines of force 10 that intersect with the coil, and that there is little electromotive force.

Likewise, with the coil 71b of the non-contact electronic tag shown on the left side of FIG. 6, one can see that there are abundant electric lines of force 10 that intersect with the coil, and that a large electromotive force is obtained thereby.

In other words, when the coil 71 of a non-contact electronic tag and a coil 41 of a non-contact electronic reading antenna run parallel to each other, an excellent readability distance can be obtained.

Because the time that it takes to read a non-contact electronic tag is much shorter compared with the time that an operator is moving, i.e., less than a few hundred milliseconds, it will be possible to select the best combination of position and angle to read a non-contact electronic tag from amongst the variety of positions and angles that are produced while the operator 5 passes through the hung door 32.

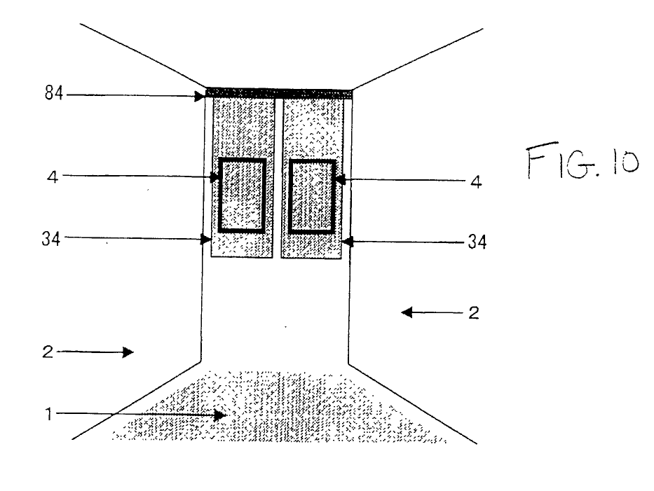

FIGS. 7 and 8 show the change in the relative position when the non-contact electronic tag 7 passes through the hung door 32 in the embodiment shown in FIG. 4. FIG. 7 shows a situation in which the open surface of the coil 71 of a non-contact electronic tag is held parallel to the direction of travel, and FIG. 8 shows a situation in which the same is held perpendicular thereto.

In FIGS. 7 and 8, the coil 71 of a non-contact electronic tag moves from the lower part of the figure to the upper part thereof, and accompanying this movement, the angle of the coil 41 of the non-contact electronic reading antenna attached to the screen gradually changes together with the hung door 32.

In FIG. 7, the coil 71 of the non-contact electronic tag gradually moves from the lower part of the figure to the upper part thereof. However, in this situation, the open surface of the coil 41 of a non-contact electronic tag reading antenna will be nearly parallel with the coil 71 of the non-contact electronic tag in the final step. This is the point at which an optimal reading distance can be obtained.

In FIG. 8, the open surface of the coil 41 of the non-contact electronic tag reading antenna will be nearly parallel with the coil 71 of the non-contact electronic tag at the initial point of movement. This is the point at which an optimal reading distance can be obtained.

In other words, in the embodiment shown in FIG. 4, all that is needed is that a sufficient reading distance be obtained at the optimum positional relationship.

In addition, because the path taken by the operator 5 is the area around the open edge of the hung door 32, attaching the non-contact electronic tag reading antenna 4 such that it is adjacent to the open side causes the non-contact electronic tag 7 to approach the non-contact electronic tag reading antenna 4, thus allowing a better reading to be obtained.

FIG. 9 is an overhead view of an embodiment of a non-contact electronic tag reading device according to the present invention that employs a revolving door.

The embodiment shown in FIG. 9 has a revolving door 33 that has four screen surfaces as screens, and four non-contact electronic tag antennas 4. The revolving door 33 is secured by means of a rotational shaft 83 such that it screens the path of a passage floor surface 1 that is defined by two wall surfaces 2. The four non-contact electronic tag reading antennas 4 are attached such that they are adjacent to the open sides of the four screen surfaces. When one proceeds down the passage, the revolving door 33 revolves together with the non-contact electronic tag reading antennas 4 in a counter clockwise direction, thereby opening the passage.

In the embodiment shown in FIG. 9 constructed in this manner, if an operator 5 approaches the revolving door 33 and pushes on the screening surface in an attempt to rotate said revolving door 33, as shown in FIG. 2, the non-contact electronic tag 7 attached to the mound-shaped article 61 will inevitably draw near to any one of the four non-contact electronic tag reading antennas 4, and reading of the non-contact electronic tag 7 will occur.

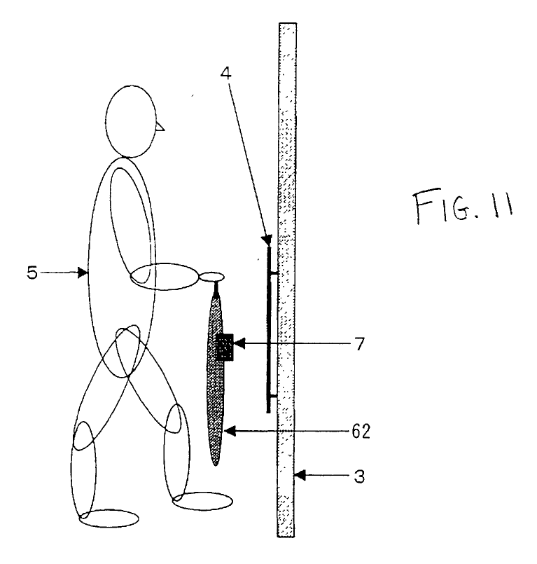

FIG. 10 shows an embodiment of a non-contact electronic tag reading device according to the present invention that employs a curtain.

The embodiment shown in FIG. 10 has two sheet curtains 34 as screens, and two non-contact electronic tag reading antennas 4. The two sheet curtains 34 are suspended by means of a curtain attachment tool or a curtain rail 84 such that they screen the path of a passage floor surface 1 that is defined by two wall surfaces 2. The two non-contact electronic tag reading antennas 4 are attached to the two sheet curtains 34. When one proceeds down the passage, the curtain 34 is pushed aside together with the non-contact electronic tag reading antennas 4, thereby opening the passage.

In the embodiment shown in FIG. 10 constructed in this manner, if an operator 5 approaches any of the two sheets of the curtain 34 and tries to push it aside by hand, as shown in FIG. 2, the non-contact electronic tag 7 attached to the mound-shaped article 61 will inevitably draw near to the non-contact electronic tag reading antennas 4, and reading of the non-contact electronic tag 7 will occur.

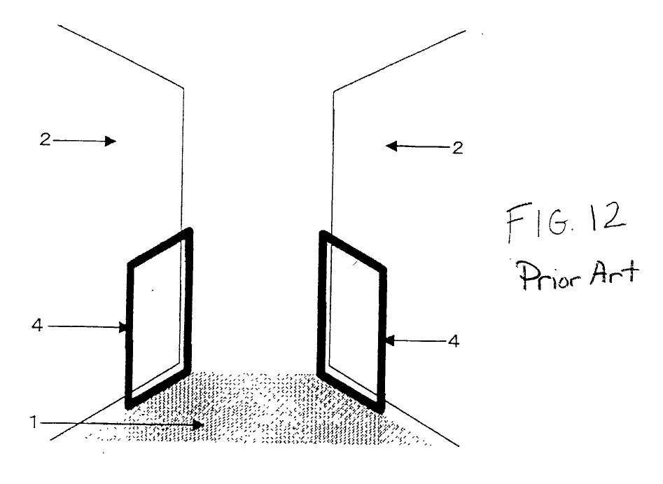

FIG. 11 shows a situation in which the non-contact electronic tag reading device according to the present invention reads a non-contact electronic tag 7 when an operator is holding an oblong article and passing through the passage.

In FIG. 11, an operator 5 is holding an oblong article 62 in one hand, and is attempting to push aside the partition 3 and pass through.

In addition, the non-contact electronic tag 7 is attached to the oblong article 62, and a non-contact electronic tag reading antenna 4 is attached to the screening-surface of the partition 3.

Because the operator 5 will push the partition 3 with his or her hand when passing through the partition 3, the non-contact electronic tag 7 will inevitably draw near to the non-contact electronic tag reading antenna 4, and a non-contact reading will take place.

However, unlike FIG. 2, because the non-contact electronic tag 7 attached to the oblong article 62 is positioned around the height of the operator 5's knee, a good height at which the non-contact electronic tag reading antenna should be attached is approximately 50 cm.

In FIG. 2, because the non-contact electronic tag 7 is positioned in the vicinity of the operator 5's chest, it is sufficient if the height at which the non-contact electronic tag reading antenna 4 is attached is no greater than 180 cm. Thus, a good height at which the non-contact electronic tag reading antenna 4 in the non-contact electronic tag reading device according to the present invention is attached is between 50 and 180 cm.

The above-described non-contact electronic tag reading device can produce the following effects.

First, the distance between a non-contact electronic tag and a non-contact electronic tag reading antenna can be shortened.

Second, the relative angle between a non-contact electronic tag and a non-contact electronic tag reading antenna can be changed to provide a good communication angle.

Third, as a result of the first and second effects, the distance needed to be able to read a non-contact electronic tag can be reduced, i.e., it is possible to reduce electric power and electromagnetic radiation.

Fourth, as a result of shortening the distance within which a non-contact electronic tag can be read, it is possible to reduce the amount of space that cannot be used for article storage due to the fact that it produces erroneous readings of non-contact electronic tags, thereby improving the efficiency of the article storage space.

1. A non-contact electronic tag reading device comprising a partition placed in a passage and a non-contact electronic tag reading antenna, wherein said non-contact electronic tag reading antenna is attached to said partition and faces said passage.

2. The non-contact electronic tag reading device according to claim 1, wherein the partition is movable.

3. The non-contact electronic tag reading device according to claim 1, wherein the partition is a sliding door, a hung door that pivots on one edge thereof, a revolving door that is supported on a rotational axis, or a curtain.

4. The non-contact electronic tag reading device according to claim 1, wherein the non-contact electronic tag reading antenna is installed adjacent to the area around the opening of the sliding door, the open side around the hung door, the outermost area around the revolving door, or the area around the opening of the curtain.

5. The non-contact electronic tag reading device according to claim 1, wherein the position in which the non-contact electronic tag reading antenna is installed is between 50 and 180 cm from the floor of the passage.

6. The non-contact electronic tag reading device according to claim 1, wherein the non-contact electronic tag reading antenna is an antenna for reading a non-contact electronic tag attached to at least apparel, jewelry, shoes, handbags, wallets, or other merchandise.

7. The non-contact electronic tag reading device according to claim 1, wherein the partition is installed at the entrance/exit of a warehouse that stores the apparel, jewelry, shoes, handbags, wallets, or other merchandise.

8. The non-contact electronic tag reading device according to claim 1, wherein the partition is installed at the entrance/exit of a stockroom that is in a store or adjacent thereto.
